(19) United States
(12) Patent Application Publication
(10) Pub. No.: US 2019/0329222 A1
(43) Pub. Date: Oct. 31, 2019

(54) METHOD FOR REGENERATION OF CARBON DIOXIDE ABSORBENT

(71) Applicant: NATIONAL CHENG KUNG UNIVERSITY, Tainan City (TW)

(72) Inventors: Chih-Yung CHEN, Tainan City (TW); Chen-Chien WANG, Tainan City (TW); Jian-Sheng SHEN, Tainan City (TW)

(21) Appl. No.: 16/397,321

(22) Filed: Apr. 29, 2019

(30) Foreign Application Priority Data
Apr. 30, 2018 (TW) 107114655

(51) Int. Cl. B01J 20/34; B01D 53/04; B01J 20/04

(52) U.S. Cl. CPC B01J 20/3441; B01D 53/0438; B01J 20/3475; B01J 20/043; B01D 2259/40096; B01D 2253/112; B01D 2257/504; B01D 2259/40094; B01J 20/3433

(57) ABSTRACT

A method for regeneration of a carbon dioxide absorbent includes steps of a) bringing a used carbon dioxide absorbent in contact with a carbon-containing dielectric material to form a dielectric energy-susceptible combination, and b) subjecting the dielectric energy-susceptible combination to a dielectric heating to remove carbon dioxide from the used carbon dioxide absorbent for the regeneration.

### CROSS-REFERENCE TO RELATED APPLICATION

This application claims priority of Taiwanese Patent Application No. 107114655, filed on Apr. 30, 2018.

### FIELD

The disclosure relates to a method for regeneration of a carbon dioxide absorbent, and more particularly to a method for regeneration of a carbon dioxide absorbent in a more efficient manner.

### BACKGROUND

A carbon dioxide absorbent such as potassium carbonate, potassium hydroxide, sodium carbonate, calcium oxide, magnesium oxide, or the like, is used to absorb carbon dioxide, resulting in formation of a used carbon dioxide absorbent. For example, calcium oxide absorbs carbon dioxide to form calcium carbonate, and potassium carbonate absorbs carbon dioxide to form potassium bicarbonate. Regeneration of the carbon dioxide absorbent is accomplished via a decomposition reaction of the used carbon dioxide absorbent, in which carbon dioxide is released from the used carbon dioxide absorbent. For example, a temperature of the decomposition reaction of potassium bicarbonate is about 250° C., and a temperature of the decomposition reaction of calcium carbonate is about 850° C.

Regeneration of the carbon dioxide absorbent by conventional methods is usually implemented by subjecting the used carbon dioxide absorbent to a heating treatment in a regeneration tower to separate carbon dioxide from the used carbon dioxide absorbent. However, such methods require energy consumption and a relatively long heating period due to a relatively slow heating rate in the regeneration tower, resulting in poor regeneration efficiency. Therefore, regeneration of the carbon dioxide absorbent by conventional methods is unsatisfactory.

### SUMMARY

Therefore, an object of the disclosure is to provide a more efficient method for regeneration of a carbon dioxide absorbent.

According to the disclosure, there is provided a method for regeneration of a carbon dioxide absorbent, which includes the steps of:

a) bringing a used carbon dioxide absorbent in contact with a carbon-containing dielectric material to form a dielectric energy-susceptible combination; and

b) subjecting the dielectric energy-susceptible combination to a dielectric heating to remove carbon dioxide from the used carbon dioxide absorbent for the regeneration.

In the method for regeneration of a carbon dioxide absorbent according to the disclosure, the used carbon dioxide absorbent is brought in contact with the carbon-containing dielectric material to form the dielectric energy-susceptible combination, followed by subjecting the dielectric energy-susceptible combination to the dielectric heating (such as a microwave heating), which is a relatively efficient heating treatment. Therefore, the decomposition reaction for the used carbon dioxide absorbent is achieved in a relatively short time such that regeneration efficiency of the carbon dioxide absorbent can be improved.

### DETAILED DESCRIPTION

A method for regeneration of a carbon dioxide absorbent according to the disclosure includes the steps of:

a) bringing a used carbon dioxide absorbent in contact with a carbon-containing dielectric material to form a dielectric energy-susceptible combination; and

b) subjecting the dielectric energy-susceptible combination to a dielectric heating to remove carbon dioxide from the used carbon dioxide absorbent for the regeneration.

Examples of the carbon dioxide absorbent that may be regenerated by the method according to the disclosure may include, but are not limited to, potassium carbonate, potassium hydroxide, sodium carbonate, calcium oxide, magnesium oxide, or the like. The term “used carbon dioxide absorbent” as used herein is a carbon dioxide absorbent that has absorbed carbon dioxide. Examples of the used carbon dioxide absorbent may include carbonates (for example, calcium carbonate) and bicarbonates (for example, potassium bicarbonate and sodium bicarbonate).

The used carbon dioxide absorbent may be partially or completely decomposed in a decomposition reaction to form a gas product and a solid product. When the used carbon dioxide absorbent is completely decomposed in the decomposition reaction, the thus formed gas product is carbon dioxide and the solid product is the regenerated carbon dioxide absorbent. On the other hand, when the used carbon dioxide absorbent is partially decomposed in the decomposition reaction, the thus formed gas product is carbon dioxide and the solid product is a mixture of the regenerated carbon dioxide absorbent and the residual used carbon dioxide absorbent.

In certain embodiments, the dielectric heating is a microwave heating. The power and the time period for the microwave heating may be adjusted depending on the temperature of the decomposition reaction of the used carbon dioxide absorbent. For example, the temperature of the decomposition reaction of potassium bicarbonate is about 250° C., and the temperature of the decomposition reaction of calcium carbonate is about 850° C.

In certain embodiments, the microwave heating is implemented at a power ranging from 800 watts to 2000 watts. In certain embodiments, the microwave heating is implemented for a time period ranging from 10 seconds to 80 seconds.

In certain embodiments, the carbon-containing dielectric material is in a form of a sheet or powders. For example, the carbon-containing dielectric material may be an electro-conductive carbon black sheet, a silicon carbide sheet, or the combination thereof. Alternatively, the carbon-containing dielectric material may be electro-conductive carbon black powders, silicon carbide powders, or the combination thereof.

Since the carbon-containing dielectric material such as the electro-conductive carbon black or the silicon carbide can absorb microwave energy via the microwave heating in a fast and efficient manner, the used carbon dioxide absorbent in contact with the carbon-containing dielectric material can be heated to the temperature of the decomposition reaction thereof so as to remove carbon dioxide from the used carbon dioxide absorbent in a shorter time period, such that regeneration efficiency of the carbon dioxide absorbent can be improved.

When the electro-conductive carbon black sheet, the silicon carbide sheet, or the combination thereof is used as the carbon-containing dielectric material, step a) is implemented by disposing the used carbon dioxide absorbent on the carbon-containing dielectric material. In certain embodiments, the used carbon dioxide absorbent is disposed in a form of a layer having an average thickness ranging from 0.2 cm to 0.5 cm. In certain embodiments, the used carbon dioxide absorbent is in an amount ranging from 0.05 g to 3.00 g per 1 cm² of the carbon-containing dielectric material. In addition, there is no specific limitation to the size and the thickness of the carbon-containing dielectric material in a form of sheet.

Furthermore, when the electro-conductive carbon black sheet, the silicon carbide sheet, or the combination thereof is used as the carbon-containing dielectric material, the regenerated carbon dioxide absorbent produced by the method according to the disclosure is formed on the carbon-containing dielectric material in a form of a sheet, and thus can be easily removed from the carbon-containing dielectric material without further separation processing.

When the electro-conductive carbon black powders, the silicon carbide powders, or the combination thereof is used as the carbon-containing dielectric material, a weight ratio of the used carbon dioxide absorbent to the carbon-containing dielectric material used in step a) is in a range from 10:1 to 5:1, and a powdery mixture including the regenerated carbon dioxide absorbent and the carbon-containing dielectric material is obtained in step b). Further separation processing is required to separate the regenerated carbon dioxide absorbent from the carbon-containing dielectric material. Therefore, the method for regeneration of a carbon dioxide absorbent according to the disclosure further includes the steps of:

c) dissolving the regenerated carbon dioxide absorbent with a solvent to form a solution so as to remove undissolved carbon-containing dielectric material in a form of powders from the solution; and d) removing the solvent from the solution to purify the regenerated carbon dioxide absorbent.

Examples of the disclosure will be described hereinafter. It is to be understood that these examples are exemplary and explanatory and should not be construed as a limitation to the disclosure.

### Example A1

Potassium bicarbonate (1.087 g) in an average thickness of 0.5 cm was disposed evenly on a silicon carbide sheet (purchased from Darton Industrial Co. Ltd., Taiwan; area: 20 cm²; thickness: 0.3 cm) to form a combination to be treated. The combination was subjected to a microwave heating at a power of 1100 watts for a time period of 30 seconds in a microwave oven (Manufacturer: Panasonic Corporation; Model No.: NN-SM332) to remove carbon dioxide from potassium bicarbonate via a decomposition reaction of potassium bicarbonate to form potassium carbonate on the silicon carbide sheet. Thereafter, potassium carbonate directly removed from the silicon carbide sheet was collected in a container.

### Examples A2 to A4

The procedures of Examples A2 to A4 were the same as those of Example A1, except that the amounts of potassium bicarbonate and the powers of the microwave heating used are as shown in Table 1 below.

In each of Examples A1 to A4, potassium bicarbonate might not be decomposed completely, and a solid product thus obtained was a mixture of potassium carbonate and residual potassium bicarbonate. Therefore, a regeneration efficiency for each of Examples A1 to A4 was expressed by a decomposition ratio of potassium bicarbonate, rather than a yield of potassium carbonate. The decomposition ratio of potassium bicarbonate was calculated according to a formula below. The higher the decomposition ratio of potassium bicarbonate is, the better the regeneration efficiency of the method for regeneration of a carbon dioxide absorbent.

Regeneration efficiency=(W1/W2)×100%

wherein

W1 is a practical total weight of carbon dioxide and steam; and

W2 is a theoretical total weight of carbon dioxide and steam.

The theoretical total weight of carbon dioxide and steam is a total weight of carbon dioxide and steam produced when potassium bicarbonate is decomposed completely to potassium carbonate, carbon dioxide, and steam. The practical total weight of carbon dioxide and steam is a total weight of carbon dioxide and steam produced in each of Examples A1 and A4, in which potassium bicarbonate is decomposed partially to potassium carbonate, carbon dioxide, and steam. The decomposition ratio of each of Examples A1 to A4 is calculated as follows.

### Example A1

If 1.087 g of potassium bicarbonate was decomposed completely to form potassium carbonate, a theoretical total weight of carbon dioxide and steam thus produced would be 0.336 g. The solid product in Example A1, which was a mixture of potassium carbonate and residual potassium bicarbonate, was 0.918 g. A practical total weight of carbon dioxide and steam produced in Example A1 was 0.169 g (i.e., 1.087−0.918=0.169). Therefore, the decomposition ratio of potassium bicarbonate in Example A1 was 50.3% (i.e., (0.169/0.336)×100%=50.3%).

### Example A2

If 1.139 g of potassium bicarbonate was decomposed completely to form potassium carbonate, a theoretical total weight of carbon dioxide and steam thus produced would be 0.352 g. The solid product in Example A2, which was a mixture of potassium carbonate and residual potassium bicarbonate, was 0.805 g. A practical total weight of carbon dioxide and steam produced in Example A2 was 0.334 g (i.e., 1.139−0.805=0.334). Therefore, the decomposition ratio of potassium bicarbonate in Example A2 was 94.9% (i.e., (0.334/0.352)×100%=94.9%).

### Example A3

If 2.005 g of potassium bicarbonate was decomposed completely to form potassium carbonate, a theoretical total weight of carbon dioxide and steam thus produced would be 0.621 g. The solid product in Example A3, which was a mixture of potassium carbonate and residual potassium bicarbonate, was 1.59 g. A practical total weight of carbon dioxide and steam produced in Example A3 was 0.415 g (i.e., 2.005−1.59=0.415). Therefore, the decomposition ratio of potassium bicarbonate in Example A3 was 66.8% (i.e., (0.415/0.621)×100%=66.8%).

### Example A4

If 2.004 g of potassium bicarbonate was decomposed completely to form potassium carbonate, a theoretical total weight of carbon dioxide and steam thus produced would be 0.620 g. The solid product in Example A4, which was a mixture of potassium carbonate and residual potassium bicarbonate, was 1.385 g. A practical total weight of carbon dioxide and steam produced in Example A4 was 0.619 g (i.e., 2.004−1.385=0.619). Therefore, the decomposition ratio of potassium bicarbonate in Example A4 was 99.8% (i.e., (0.619/0.620)×100%=99.8%).

TABLE 1

| | Used carbon dioxide | | Carbon-containing | | | Microwave | | Carbon | |
|---|---|---|---|---|---|---|---|---|---|
| | absorbent | | dielectric material | | | heating | | dioxide | Decomposition |
| | | Amount | | Area | Thickness | Power | Time | absorbent | ratio |
| Example | Type | (g) | Type | (cm²) | (cm) | (W) | (sec) | Type | (%) |
| A1 | Potassium | 1.087 | Silicon | 20 | 0.3 | 1100 | 30 | Potassium | 50.3 |
| A2 | bicarbonate | 1.139 | carbide | 20 | 0.3 | 1100 | 40 | carbonate | 94.9 |
| A3 | | 2.005 | sheet | 20 | 0.3 | 1100 | 40 | | 66.8 |
| A4 | | 2.004 | | 20 | 0.3 | 1100 | 60 | | 99.8 |

### Example B1

Potassium bicarbonate (5 g) was mixed with electro-conductive carbon black powders (1 g) to form a combination to be treated. The combination was subjected to a microwave heating at a power of 800 watts for a time period of 10 seconds in a microwave oven (Manufacturer: Panasonic Corporation; Model No.: NN-SM332) to remove carbon dioxide from potassium bicarbonate via a decomposition reaction of potassium bicarbonate to form a powdery coarse product containing potassium carbonate and electro-conductive carbon black powders. Potassium carbonate contained in the powdery coarse product was dissolved with water to form an aqueous potassium carbonate solution so as to remove undissolved electro-conductive carbon black powders from the aqueous potassium carbonate solution. Thereafter, the aqueous potassium carbonate solution was heated via the microwave heating to remove the water from the aqueous potassium carbonate solution so as to obtain potassium carbonate. The decomposition ratio of potassium carbonate calculated according to the aforesaid procedure was 94%. The electro-conductive carbon black powders removed from the aqueous potassium carbonate solution was collected for reuse.

As shown in each of Examples A1 to A4 and B1, the carbon-containing dielectric material such as the silicon carbide sheet or the electro-conductive carbon black powders can absorb microwave energy in a fast and efficient manner via the microwave heating, with a significantly short time period that ranges from 10 seconds to 60 seconds. Potassium bicarbonate (i.e., the used carbon dioxide absorbent) in contact with the carbon-containing dielectric material can be heated to the temperature of the decomposition reaction thereof in a significantly shorter time period so as to improve the regeneration efficiency of potassium carbonate (i.e., the carbon dioxide absorbent), which is shown by the decomposition ratio of potassium bicarbonate of at least 50.3%, and even as high as 99.8%.

In view of the aforesaid, in the method for regeneration of a carbon dioxide absorbent according to the disclosure, the used carbon dioxide absorbent is brought in contact with the carbon-containing dielectric material to form the dielectric energy-susceptible combination, followed by subjecting the dielectric energy-susceptible combination to the dielectric heating (such as a microwave heating), which is a relatively efficient heating treatment. Therefore, the temperature of the decomposition reaction for the used carbon dioxide absorbent can be achieved in a relatively shorter time period such that the regeneration efficiency of the carbon dioxide absorbent can be improved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for regeneration of a carbon dioxide absorbent, comprising the steps of:
a) bringing a used carbon dioxide absorbent in contact with a carbon-containing dielectric material to form a dielectric energy-susceptible combination; and
b) subjecting the dielectric energy-susceptible combination to a dielectric heating to remove carbon dioxide from the used carbon dioxide absorbent for the regeneration.

2. The method according to claim 1, wherein the dielectric heating is a microwave heating.

3. The method according to claim 1, wherein the carbon-containing dielectric material is in a form of a sheet or powders.

4. The method according to claim 3, wherein the carbon-containing dielectric material is selected from the group consisting of an electro-conductive carbon black sheet, a silicon carbide sheet, and the combination thereof.

5. The method according to claim 3, wherein the carbon-containing dielectric material is selected from the group consisting of electro-conductive carbon black powders, silicon carbide powders, and the combination thereof.

6. The method according to claim 5, further comprising a step of c) dissolving regenerated carbon dioxide absorbent with a solvent to form a solution.

7. The method according to claim 6, further comprising a step of d) removing the solvent from the solution to purify the regenerated carbon dioxide absorbent.

8. The method according to claim 2, wherein the microwave heating is implemented at a power ranging from 800 watts to 2000 watts.

9. The method according to claim 2, wherein the microwave heating is implemented for a time period ranging from 10 seconds to 80 seconds.

10. The method according to claim 4, wherein step a) is implemented by disposing the used carbon dioxide absorbent on the carbon-containing dielectric material.

11. The method according to claim 10, wherein the used carbon dioxide absorbent is laid in a form of a layer having an average thickness ranging from 0.2 cm to 0.5 cm.

12. The method according to claim 10, wherein the used carbon dioxide absorbent is in an amount ranging from 0.05 g to 3.00 g per 1 cm² of the carbon-containing dielectric material.

13. The method according to claim 4, wherein a weight ratio of the used carbon dioxide absorbent to the carbon-containing dielectric material is in a range from 10:1 to 5:1.
